(19) United States
(12) Patent Application Publication
(10) Pub. No.: US 2004/0028041 A1
(43) Pub. Date: Feb. 12, 2004

(54) Packet processing device

(76) Inventor: Kazuhito Yasue, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/339,203

(22) Filed: Jan. 9, 2003

(30) Foreign Application Priority Data
Aug. 9, 2002 (JP) 2002-233889

(51) Int. Cl. H04L 12/28

(52) U.S. Cl. 370/389; 370/412

(57) ABSTRACT

In a packet processing device for controlling a band of a packet, a preprocessor assigns a time stamp to a received packet, and a shared resource portion performs a band control of packets based on reception order information (e.g. time stamp, sequence No.) of the packets distributed to distributed processors.

### BACKGROUND OF THE INVENTION

1. Field of the Invention

The present invention relates to a packet processing device, and in particular to a packet processing device for controlling a band of a packet (frame).

In recent years, together with advancements of communication technology, amounts of communication information have been rapidly increasing not only for data but also for voice, static images, moving images, or the like. In a communication network for transmitting such information, a band (bandwidth) control determining whether or not the flow of each information is within a predetermined band to control a packet has become all the more important for securing reliability of the communication.

2. Description of the Related Art

FIG. 13 shows an arrangement of a general packet switching apparatus. This packet switching apparatus is composed of line (trunk) processors 110_1, 110_2, . . . , 110_{—}k (hereinafter, occasionally represented by a reference numeral 110) which respectively terminate physical lines 130_11-130_1i, 130_21-130_2i, . . . , 130_{—}k1-130_{—}ki (hereinafter, occasionally represented by a reference numeral 130), packet processing devices 100z_1-100z_{—}k (hereinafter, occasionally represented by a reference numeral 100z) respectively connected to the line processors 110, and a switch 120 connected to these packet processing devices 100z_1-100z_{—}k.

It is to be noted that while a plurality of physical lines 130 are shown as being connected to the line processor 110 in FIG. 13, a single physical line 130 may be connected to each line processor 110.

In operation, the line processor 110_{—}j, for example, transfers a packet 90 taken out of a line signal, from the physical line 130_{—}ji to the packet processing device 100z_{—}j.

The packet processing device 100z_{—}j performs the following ingress processings (1)-(4) to the packet 90 received from the line processor 110j, and then transfers the packet 90 to the switch 120.

(1) Classifying: The flow type of the packet 90 is determined based on a source, destination, protocol, or the like of the packet 90.

(2) Filtering: The packet 90 prohibited from being passed therethrough is discarded.

(3) Routing: Which packet processing device 100z the packet 90 is to be transferred to through the switch 120 is determined based on destination information or the like held by the packet 90, and information (internal tag) indicating a transferring destination is assigned to the packet 90.

(4) Band control: The packet flow is controlled for every packet type designated by the above-mentioned classifying.

The switch 120 transfers the packet 90 received from the packet processing device 100z_{—}j to e.g. the packet processing device 100z_k indicated by its internal tag.

The packet processing device 100z_{—}k performs the following egress processings (1) and (2) to the packet 90 received from the switch 120, and then transfers the packet 90 to the line processor 110.

(1) Filtering: The packet 90 prohibited from being passed therethrough is discarded.

(2) Routing: The physical line 130 to which the packet 90 is to be transferred through the line processor 110 is determined based on the destination information or the like held by the packet 90, and the information (internal tag) designating the transferring destination is assigned to the packet 90.

The line processor 110_{—}k outputs the packet 90 received from the packet processing device 100z_{—}k to e.g. the physical line 130_{—}k1 designated by the internal tag as a line signal.

FIG. 14 shows an arrangement of a general packet processing device 100z which distributes packets to be processed. This packet processing device 100z improves the processing performance by distributing the packets for processing.

The packet processing device 100z is composed of a preprocessor 10z, distributed processors 20z_1-20z_{—}n (hereinafter, occasionally represented by a reference numeral 20z), a shared resource portion 40z, and a postprocessor 30z. This arrangement is common to the packet processing device 100z performing the ingress processing and that performing the egress processing.

The preprocessor 10z transmits a packet received from the upstream portion to any one of the distributed processors 20z_1-20z_{—}n. For this distributing algorithm, there are e.g. a method in which an output queue (not shown) is provided corresponding to the distributed processors 20z to monitor the queue length of the output queue, a round-robin method, and the like.

Also, the preprocessor 10z assigns a sequence No. to each packet so that an order of distributed packets may be reproduced by the downstream postprocessor 30z.

The distributed processors 20z perform various processings such as edit processing and retrieval processing to the received packet, so that the packet in which the processings have been completed is provided to the postprocessor 30z.

The shared resource portion 40z is a resource of a retrieval engine, a shared memory, or the like shared by the distributed processors 20z_1-20z_{—}n, and accessed from the distributed processors 20z.

The postprocessor 30z reproduces the order of the packets inputted to the preprocessor 10z based on the sequence No. assigned to each packet, and then transfers the packets to the downstream portion.

The packet processing device 100z further performs a band control for determining whether or not a packet resides within a predetermined band and for controlling the packet. Namely, a band control for discarding, marking (tagging) packets in violation of a predetermined band, or the like is performed.

Hereinafter, (1) jumping window band control system, (2) sliding window band control system, and (3) GCRA (Generic Cell Rate Algorithm) band control system will be described as general band control systems.

(1) Jumping Window Band Control System

FIG. 15 shows a jumping window band control system. This system evaluates a band based on a total byte number of packets respectively received in windows Wn−1, Wn, Wn+1, Wn+2 (in FIG. 15, window time width Tw=time Tn−Tn−1=time Tn+1−Tn=time Tn+2−Tn+1=time Tn+3−Tn+2) of a fixed time width Tw divided on an absolute time.

This system is easy to be mounted. However, e.g. information in the past window Wn−1 can not be transferred to the next window Wn. When the byte number of packets received in the window Wn−1=“0” and the total byte number of the received packets in the next window Wn exceeds a contracted specified value, for example, it is determined as a band violation even when the average of the total byte numbers of the packets received in the window Wn−1 and window Wn does not exceed the specified value.

(2) Sliding Window Band Control System

FIG. 16 shows a sliding window band control system. This system evaluates the band based on a total byte number of packets received in the windows of the past fixed time width Tw before arrival times Ta, Tb, and Tc every time e.g. packets fa, fb, and fc arrive.

This system can dynamically evaluate the band, but is difficult to be mounted.

(3) GCRA Band Control System

FIGS. 17A-17C show a GCRA band control system. This system evaluates the band based on a reception interval of continuous two packets. This system is theoretically equivalent to a Leaky Bucket band control system.

The algorithm of the GCRA band control system will now be described.

It is supposed that TAT=Theoretical Arrival Time of packet, T actual arrival time of packet, I=Increment Parameter, L=Limit Parameter, and n=Packet Length. Among these, the values of I and L are preset.

\mathring{1} After starting the control, the first received packet is unconditionally determined to be band control result=“conforming”, and the next TAT is calculated by the following equation (1):

TAT=T+nI Eq.(1)

\mathring{2} Hereafter, every time a packet (length n, arrival time T) is received, T is compared with TAT to determine “conforming” or “nonconforming” and calculate next TAT.

(a) In case of comparison result: TAT<T (packet reception after the time TAT, see FIG. 17A), the band control result=“conforming”, and the next TAT is calculated with the time T being made a base point by the following equation (2):

TAT=T+nI Eq.(2)

(b) In case of comparison result: TAT−L≦T≦TAT (packet reception after the time (TAT−L) and before the time TAT, see FIG. 17B), the band control result=“conforming”, and the next TAT is calculated with the present TAT being made a base point by the following equation (3):

Next TAT=present TAT+nI Eq.(3)

(c) In case of comparison result: T<TAT−L (packet reception before the time (TAT−L), see FIG. 17C), the band control result=“nonconforming”, and the next TAT is calculated by the following equation (4), in which TAT is not updated:

Next TAT=present TAT Eq.(4)

When such a band control is performed by the distributed processors 20z, the packets are distributed to the distributed processors 20z, so that the continuity of the packets can not be kept. Accordingly, a band control with high accuracy has not been able to be performed. Therefore, as the prior art band control, there has been a system (1) in which a band control is performed by the preprocessor 10z or a system (2) in which a band control is performed by the postprocessor 30z.

(1) System for Performing Band Control by Preprocessor.

Since the band control is performed before the distribution processing, there is less fluctuation in packet intervals, so that this system has an advantage of enabling a band control with high accuracy. However, in order to perform the band control, classifying is required to be performed before the band control. This is accompanied by generation of processing information, thereby oppressing the band.

(2) System for Performing Band Control by Postprocessor

This system has an advantage of performing classifying by the distributed processor 20z or the shared resource portion 40z. However, information for notifying classified result information to the postprocessor 30z by the distributed processor 20z or the shared resource portion 40z is required, resulting in the oppression of the band.

Also, since packet flows are distributed and joined upstream, there is a disadvantage of the fluctuation in the packet intervals being made large and the accuracy of the band control being reduced.

### SUMMARY OF THE INVENTION

It is accordingly an object of the present invention to provide a packet processing device for controlling a band of a packet, whereby a band control for a packet is performed without oppressing the band of the packet processing device itself, and the packet band control with high accuracy is performed.

In order to achieve the above-mentioned object, a packet processing device according to the present invention comprises: a preprocessor for transmitting a received packet to any one of a plurality of output terminals; a plurality of distributed processors connected to each of the output terminals for processing the packet from each of the output terminals; a shared resource portion for performing a band control of the packet based on reception order information of each packet distributed to each of the distributed processors; and a postprocessor for joining the packets from each of the distributed processors to be outputted (claim 1).

The basic arrangement of a packet processing device 100 according to the present invention is the same as that of the general packet processing device 100 shown in FIG. 14, in which the packet processing device 100 according to the present invention is composed of a preprocessor 10, n distributed processors 20_1-20_{—}n (hereinafter, occasionally represented by a reference numeral 20), a shared resource portion 40, and a postprocessor 30 instead of the prior art preprocessor 10z, distributed processors 20z_1-20z_{—}n, shared resource portion 40z, and postprocessor 30z.

The packet processing device 100 of the present invention is basically different from the prior art packet processing device 100z in that the shared resource portion 40 collects reception order information of packets distributed to the distributed processors 20 and a band control of the packet is performed based on this information.

Namely, the preprocessor 10 transmits the received packet to a single output terminal selected from among a plurality of output terminals by e.g. the prior art predetermined algorithm.

The distributed processors 20_1-20_{—}n respectively perform processing the packets received from the output terminal of the preprocessor 10.

The shared resource portion 40 performs a band control for determining whether or not the packet is within a predetermined band, based on the reception order information of the packets distributed to the distributed processors 20_1-20_{—}n.

The postprocessor 30 joins the packets processed by the distributed processors to be outputted.

Accordingly, the packet processing device of the present invention performs e.g. discarding a packet which violates a band, or notifying a band violation to downstream portions, and to a transmission source of the packet, or the like without oppressing the band of the packet processing device itself based on a band control result, thereby enabling the band control of the packet to be realized.

Thus, it becomes possible to perform the band control of the packets distributed to the distributed processors by the shared resource portion 40, and to perform the band control of the packets without oppressing the band since redundant processing information or notification information is not required.

It is to be noted that processing such as the above-mentioned discarding the packet and notifying the band violation is performed by a predetermined processor. e.g. a distributed processor, a postprocessor, or the like based on the band control result of the present invention.

Also, in the present invention according to the above-mentioned present invention, the reception order information may comprise time information assigned to the packet (claim 2).

Namely, the shared resource portion 40 determines an accurate position of the packet in time sequence based on time information (e.g. time stamp) assigned to the packet, and performs the band control. Thus, it becomes possible to correct fluctuations of the packet in time sequence arising in the processing between the time when the time information is assigned to the packet and the time when the band control is performed, thereby enabling the band control with high accuracy.

Also, in the present invention according to the above-mentioned present invention, the preprocessor may assign the time information to the packet (claim 3).

Also, in the present invention according to the above-mentioned present invention, the distributed processor may assign the time information to the packet (claim 4).

Namely, it is possible to assign the time information (time stamp) to the packet by either the preprocessor 10 or the distributed processor 20. It is to be noted that less fluctuation of the time information arises in time sequence when the time information is assigned by the preprocessor 10 than when it is assigned by the distributed processor 20, so that an accurate band control can be performed in the former case.

When the preprocessor 10 assigns the time stamp to the packet at the most preceding stage, for example, the shared resource portion 40 can perform the accurate band control based on the time when the packet arrives at the preprocessor 10 without being influenced by the fluctuation of the packet due to subsequent processing at the preprocessor 10 and the distribution processing of the distributed processor 20.

Also, in the present invention according to the above-mentioned present invention, the shared resource portion may include an order-correction processor for rearranging the packets in time sequence based on the time information (claim 5).

Namely, an order-correction processor restores a packet order which has changed in time sequence due to distribution by the distributed processor 20 based on the time information (time stamp) assigned to this packet.

Thus, it becomes possible to process the packet in time sequence and to simplify the band control.

Also, in the present invention according to the above-mentioned present invention, the reception order information may further include a sequence No., assigned by the preprocessor, indicating a reception order of a packet, and the shared resource portion may include an order-correction processor for rearranging the packets in time sequence based on the sequence No. (claim 6).

Thus, it becomes possible to process the packet in time sequence, and to simplify the band control.

Also, in the present invention according to the above-mentioned present invention, the shared resource portion may perform the band control by any one of a jumping window band control system, a sliding window band control system, and a GCRA band control system (claim 7).

Namely, the shared resource portion 40 may perform the band control by the jumping window band control system shown in FIG. 15, the sliding window band control system shown in FIG. 16, or the GCRA band control system shown in FIG. 17.

Also, in the present invention according to the above-mentioned present invention, the shared resource portion may be further provided with a classifying processor for classifying packets by flow and may perform the band control by flow (claim 8).

Also, in the present invention according to the above-mentioned present invention, each of the distributed processors may be further provided with a classifying processor for classifying packets by flow, and the shared resource portion may perform the band control by flow (claim 9).

Also, in the present invention according to the above-mentioned present invention, the preprocessor may be further provided with a classifying processor for classifying packets by flow, and the shared resource portion may perform the band control by flow (claim 10).

Namely, a classifying processor 60 is arranged at the shared resource portion 40, the distributed processor 20, or the preprocessor 10. The classifying processor 60 classifies the packets by flow, and the shared resource portion 40 performs the band control by flow.

Thus, the band control by flow becomes possible. It is to be noted that as for an arrangement position of the classifying processor, the position in which the band oppression is least has only to be selected. In general, the system in which the classifying processor is arranged at the distributed processor 20 oppresses the band little since the classifying processing is distributed.

Also, in the present invention according to the above-mentioned present invention, the reception order information may comprise a sequence No. indicating a reception order of the packet, and the shared resource portion may be further provided with an order-correction processor for rearranging the packets in order of the sequence No. and a timer for clocking a time when the packet is inputted to the shared resource portion itself, and may perform the band control based on the time (claim 11).

Namely, a sequence No. indicating a reception order of the packet is used as the reception order information. The shared resource portion 40 is further provided with an order-correction processor and a timer. The order-correction processor rearranges the packets in order of the sequence No., and the timer clocks the time when the packet is inputted to the shared resource portion 40. Based on this time the shared resource portion 40 performs the band control of the packet.

Thus, the shared resource portion 40 can perform the band control. Namely, even when the packets are distributed to the distributed processors 20, the band control can be performed based on the time when the packets arrive at the shared resource portion 40.

For this band control, it is not necessary to assign the time stamp to the packet.

Furthermore, in the present invention according to the above-mentioned present invention, the preprocessor may assign the sequence No. to the packet (claim 12).

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of a packet processing device according to the present invention;

FIG. 2 is a block diagram showing an embodiment of a preprocessor in a packet processing device according to the present invention;

FIGS. 3A and 3B are diagrams showing a format example of a packet in a preprocessor in a packet processing device according to the present invention;

FIG. 4 is a diagram showing an operation example of a distributed processor in a packet processing device according to the present invention;

FIGS. 5A-5D are diagrams showing a format example of each information in a packet processing device according to the present invention;

FIG. 6 is a block diagram showing an embodiment (1) of an order correction in a distributed processor and an order-correction processor in a packet processing device according to the present invention;

FIG. 7 is a block diagram showing an embodiment (2) of an order correction in a distributed processor and an order-correction processor in a packet processing device according to the present invention;

FIG. 8 is a block diagram showing an embodiment of a classifying processor in a packet processing device according to the present invention;

FIG. 9 is a block diagram showing an embodiment (1) of a band control processor in a packet processing device according to the present invention;

FIG. 10 is a block diagram showing an embodiment (2) of a band control processor in a packet processing device according to the present invention;

FIG. 11 is a block diagram showing an embodiment (3) of a band control processor in a packet processing device according to the present invention;

FIG. 12 is a block diagram showing in more detail an embodiment (3) of a band control processor in a packet processing device according to the present invention;

FIG. 13 is a block diagram showing an arrangement of a general packet switching apparatus;

FIG. 14 is a block diagram showing an arrangement of a general packet processing device;

FIG. 15 is a diagram showing a general jumping window band control system;

FIG. 16 is a diagram showing a general sliding window band control system; and

FIGS. 17A-17C are diagrams showing a general GCRA band control system.

### DESCRIPTION OF THE EMBODIMENTS

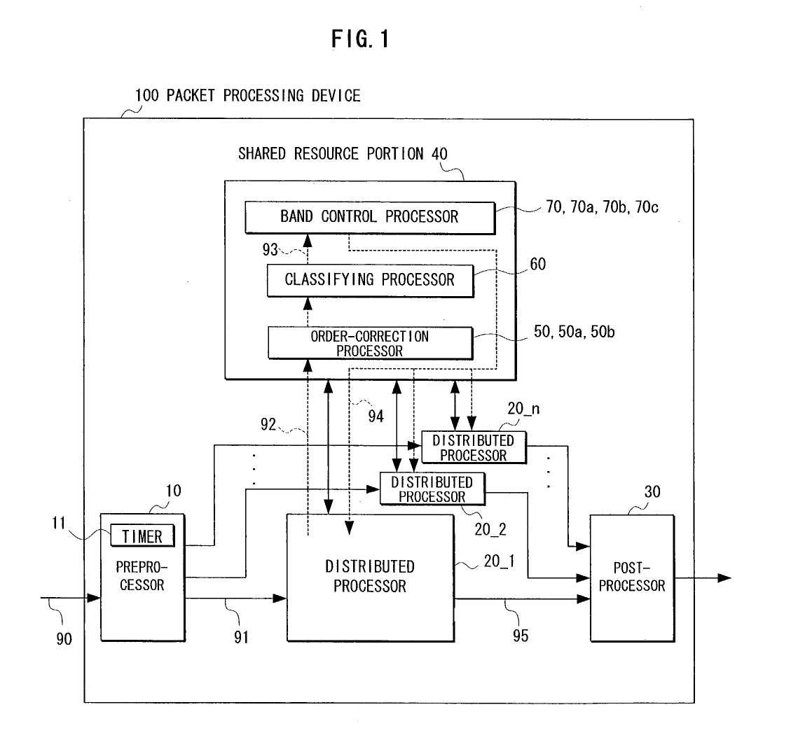

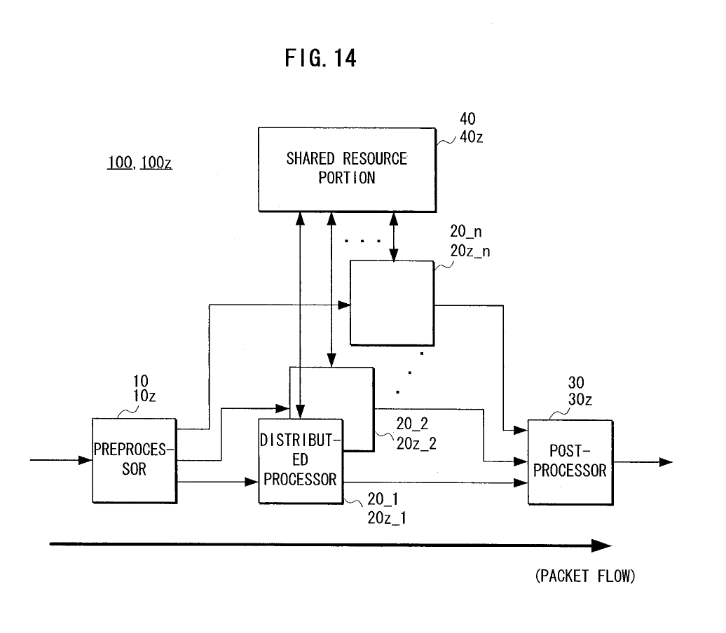

FIG. 1 shows an embodiment of a packet processing device 100 according to the present invention. This packet processing device 100 is composed of a preprocessor 10, distributed processors 20_1-20_{—}n, a postprocessor 30, and a shared resource portion 40, in the same manner as the general packet processing device 100z shown in FIG. 14.

FIG. 1 shows the shared resource portion 40 specifically in detail, which is characteristically composed of an order-correction processor 50, a classifying processor 60, and a band control processor 70.

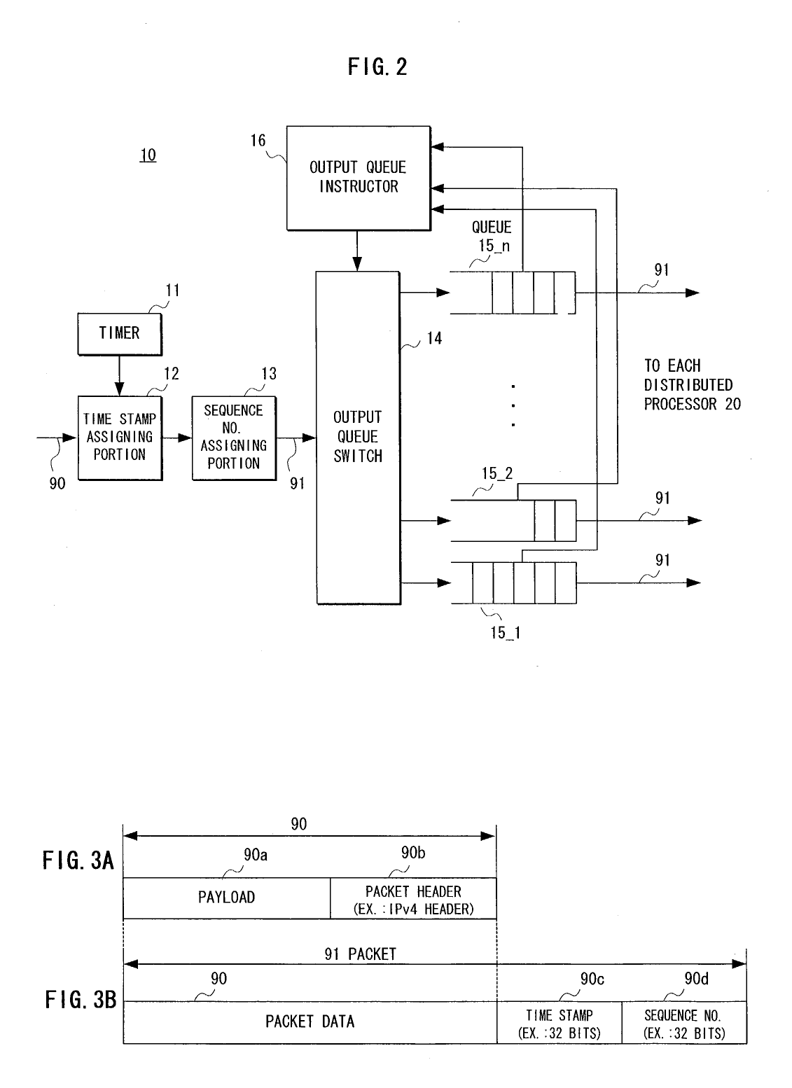

FIG. 2 shows an embodiment of the preprocessor 10 shown in FIG. 1. This preprocessor 10 is provided with a timer 11, a time stamp assigning portion 12 for adding, to the received packet 90, a time indicated by the timer 11, i.e. a time stamp 90c to be outputted, and a sequence No. assigning portion 13 for outputting a packet 91 obtained by further assigning a sequence No. 90d to the packet 90.

Furthermore, the preprocessor 10 is provided with an output queue switch 14 for outputting the packet 91 to any of “n” output terminals, queues 15_1-15_{—}n (hereinafter, occasionally represented by a reference numeral 15) connected to the output terminals of the output queue switch 14, for queuing the packet 91 provided from the output queue switch 14, and an output queue instructor 16 for detecting a queuing state of the queue 15, for detecting e.g. the queue 15 having the smallest number of bytes queued, and for instructing the output queue switch 14 to provide the next packet 91 to this queue 15.

FIG. 3A shows a format example of the packet 90 inputted to the preprocessor 10. This packet 90 is composed of a payload 90a and a packet header 90b (e.g. IPv4 header).

FIG. 3B shows a format example of the packet 91 provided to the output queue switch 14. This packet 91 is composed of the packet 90 shown in FIG. 3A as well as the time stamp 90c and the sequence No. 90d assigned to the packet 90.

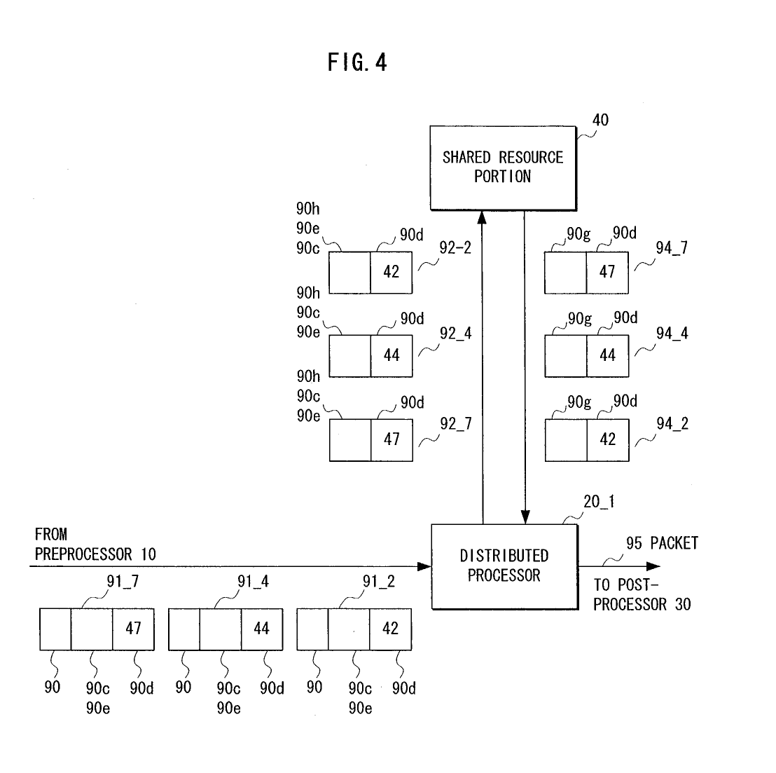

FIG. 4 shows an operation example of the distributed processor 20 shown in FIG. 1. The distributed processor 20 sequentially receives the packets 91_2, 91_4, and 91_7 (hereinafter, occasionally represented by a reference numeral 91) received from the preprocessor 10, and provides, to the shared resource portion 40, information 92_2, 92_4, and 92_7 (hereinafter, occasionally represented by a reference numeral 92) composed of the sequence No. 90d, the time stamp 90c, or the like respectively assigned to the packets 91.

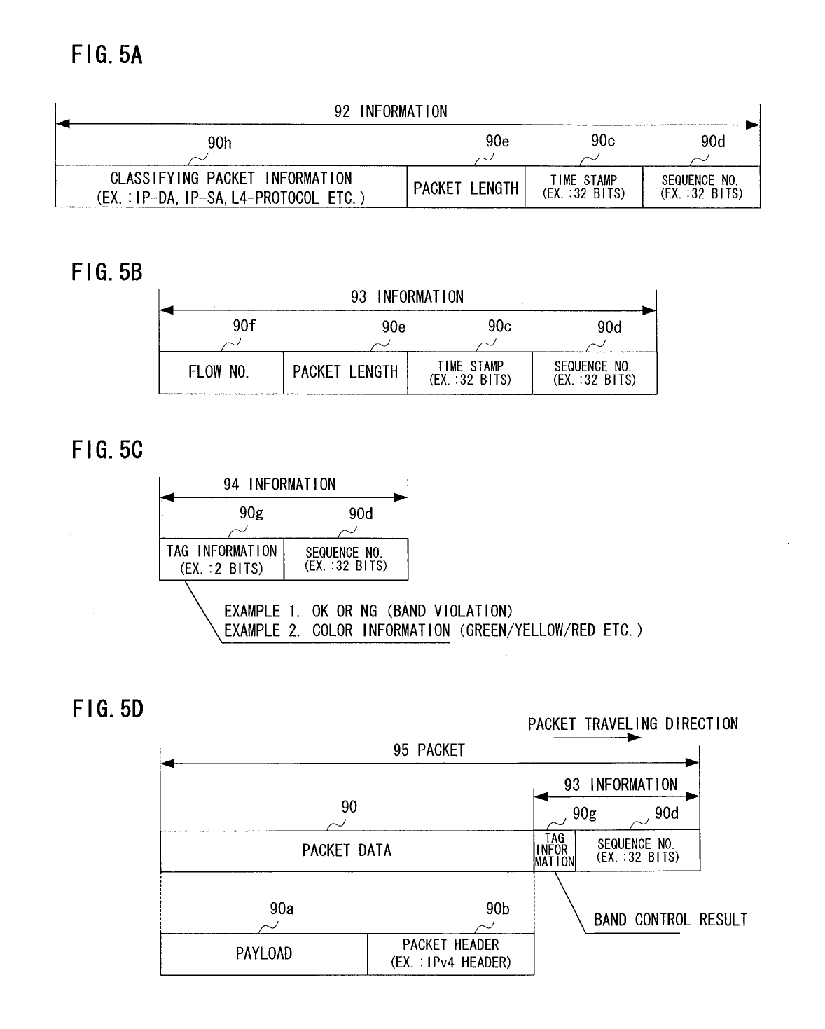

FIGS. 5A-5D show information examples transmitted by the distributed processor 20 and the shared resource portion 40. FIG. 5A shows an arrangement of the information 92. This information 92 is composed of the sequence No. 90d, the time stamp 90c, a packet length 90e, and packet information 90h. The packet information 90h is one necessary for classifying the packet 91, that is a destination IP address, a source IP address, an L4 protocol, or the like.

Also, the distributed processor 20 reversely receives, from the shared resource portion 40, information 94_2, 94_4, and 94_7 (hereinafter, occasionally represented by a reference numeral 94) composed of tag information 90g which is a band control result and the sequence No. 90d. FIG. 5C shows a format example of this information 94, which is composed of the sequence No. 90d and the tag information 90g.

Furthermore, the distributed processor 20 provides, to the postprocessor 30, a packet 95 to which not the time stamp 90c (see FIG. 3B) of the packet 91 but the tag information 90g of the information 94 for the same sequence No. 90d as the sequence No. 90d assigned to its own packet 91 is assigned.

FIG. 5D shows a format example of the packet 95. This packet 95 is composed of the packet 90, the sequence No. 90d, and the tag information 90g.

FIG. 5B will be described later.

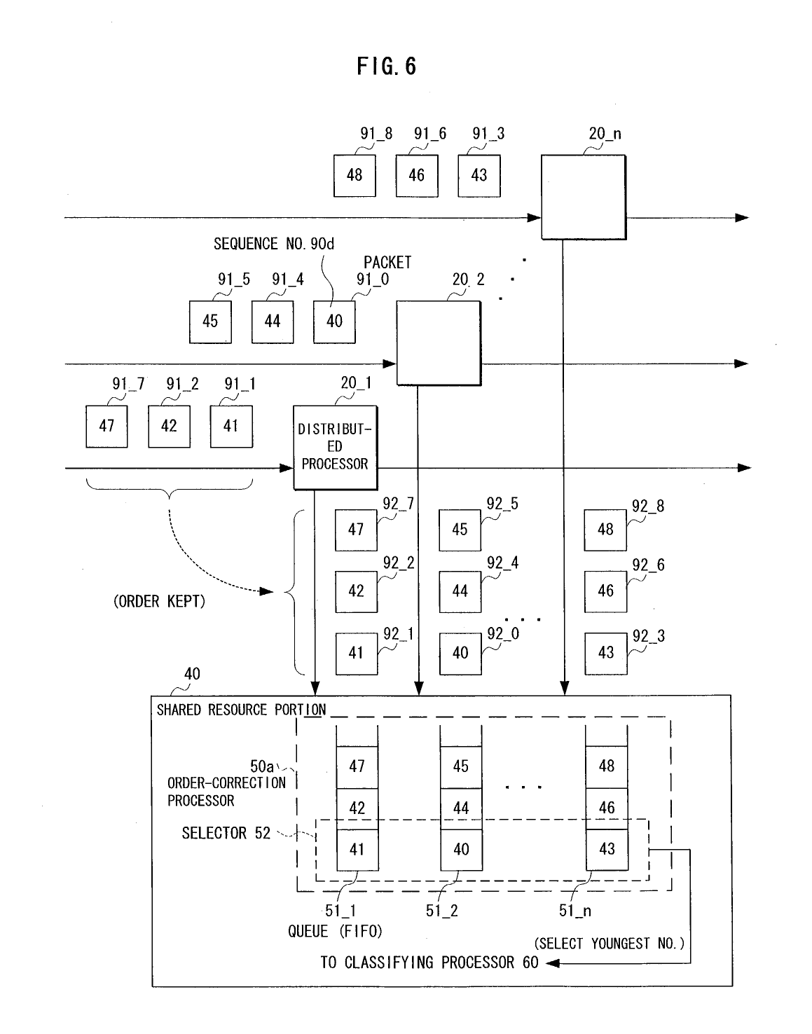

FIG. 6 shows an embodiment (1) for correcting the reception order of the information 92. In this embodiment (1), each of the distributed processors 20 provides the information 92 (see FIG. 5C; only the sequence No. 90d is shown in FIG. 6) to an order-correction processor 50a in the same order as the reception order of the packet 91 received from the preprocessor 10.

The order-correction processor 50a is composed of queues (FIFO) 51_1-51-n (hereinafter, occasionally represented by a reference numeral 51) respectively corresponding to the distributed processors 20_1-20_{—}n, and a selector 52.

The queue 51 stores the information 92 received from the distributed processor 20 in the FIFO, and the selector 52 selects the information 92 having the youngest sequence No. 90d from among all of the queues 51 to be provided to the classifying processor 60.

Thus, the information 92 of the corresponding packet 90 is provided to the classifying processor 60 in the same order as the packet 90 inputted to the preprocessor 10.

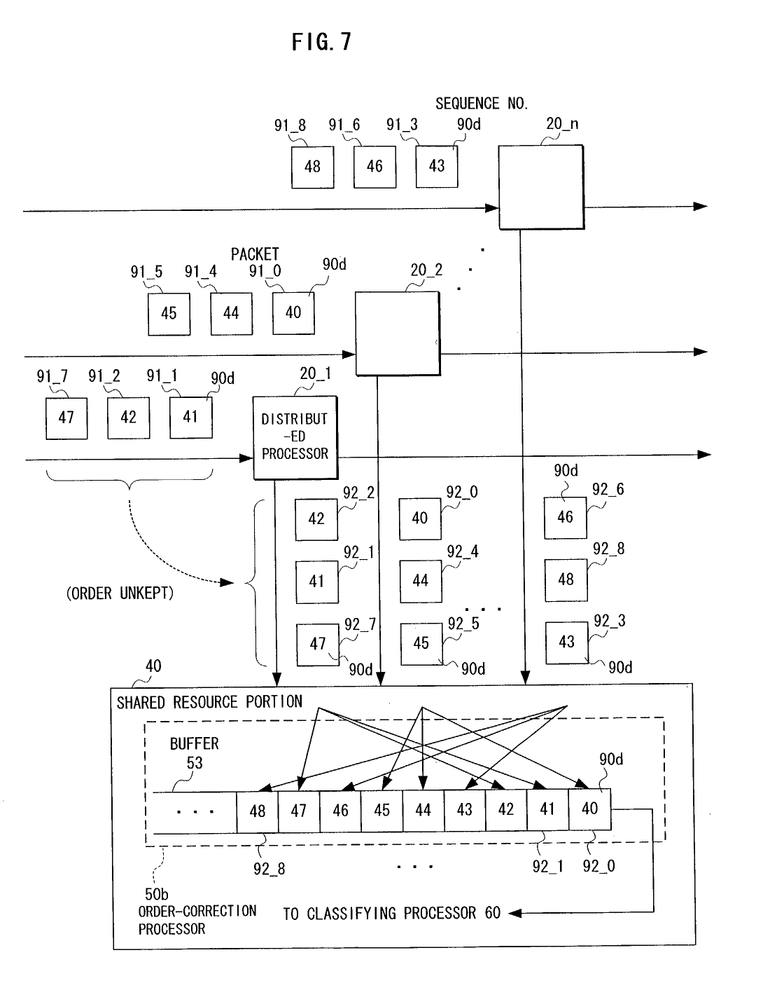

FIG. 7 shows an embodiment (2) for correcting the reception order of the information 92. In this embodiment (2), different from the embodiment (1), the distributed processor 20 provides the information 92 corresponding to the packet 91 to an order-correction processor 50b in the different order from that of the packet 91 being inputted to its own distributed processor 20.

The distributed processor 20_1, for example, sequentially receives the packets 91_1, 91_2, and 91_7 whose sequence Nos. 90d are respectively “41”, “42”, and “47”. Then, the distributed processor 20_1 sequentially provides the information 92_7, 92_1, and 92_2 whose sequence Nos. 90d are respectively “47”, “41”, and “42” to the order-correction processor 50b.

When the internal processing of the distributed processor 20 is distributed and performed, such a case where the order is not kept occurs.

It is to be noted that in FIG. 7, in the same way as FIG. 6, only the sequence No. 90d is shown in the packet 91 and the information 92, while the time stamp 90c or the like is omitted.

The order-correction processor 50b is provided with a buffer 53, in which the information 92_0, 92_1-92_8 received from the distributed processors 20_1-20_{—}n is stored in the order of the sequence No. 90d. Then, the order-correction processor 50b reads the information 92 from the buffer 53 in the order of sequence No. 90d (40, 41, . . . , 48, . . . ) to be provided to the classifying processor 60.

It is to be noted that in FIGS. 6 and 7, the distributed processor 20 and the order-correction processor 50a or 50b may correct the order of the packet by using the time stamp 90c instead of the sequence No. 90d. In this case, the sequence No. 90d is not necessary.

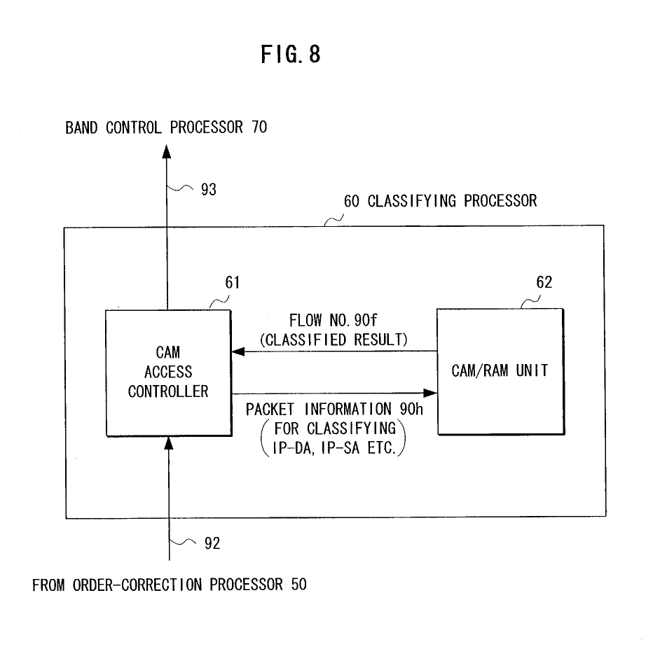

FIG. 8 shows an embodiment of the classifying processor 60, which is composed of a CAM (Content Address Memory) access controller 61 and a CAM/RAM unit 62.

A flow No. 90f corresponding to the packet information 90h is registered in the CAM/RAM unit 62.

The CAM access controller 61 provides the classifying packet information 90h (see FIG. 5A) within the information 92 to the CAM/RAM unit 62, reads the flow No. 90f corresponding to the packet information 90h, and provides information 93, in which the flow No. 90f instead of the packet information 90h within the information 92 is added, to the band control processor 70.

FIG. 5B shows this information 93, which is composed of the sequence No. 90d, the time stamp 90c, the packet length 90e, and the flow No. 90f.

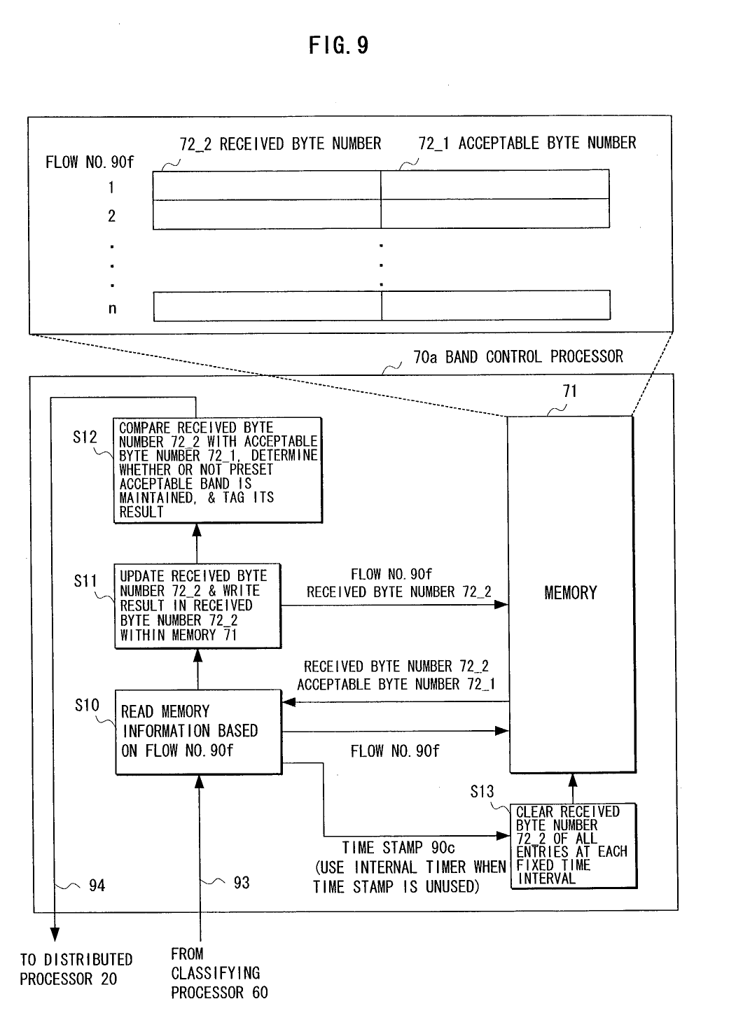

Embodiments (1)-(3) of the band control processor 70 will now be described in operation, referring to FIGS. 9-12.

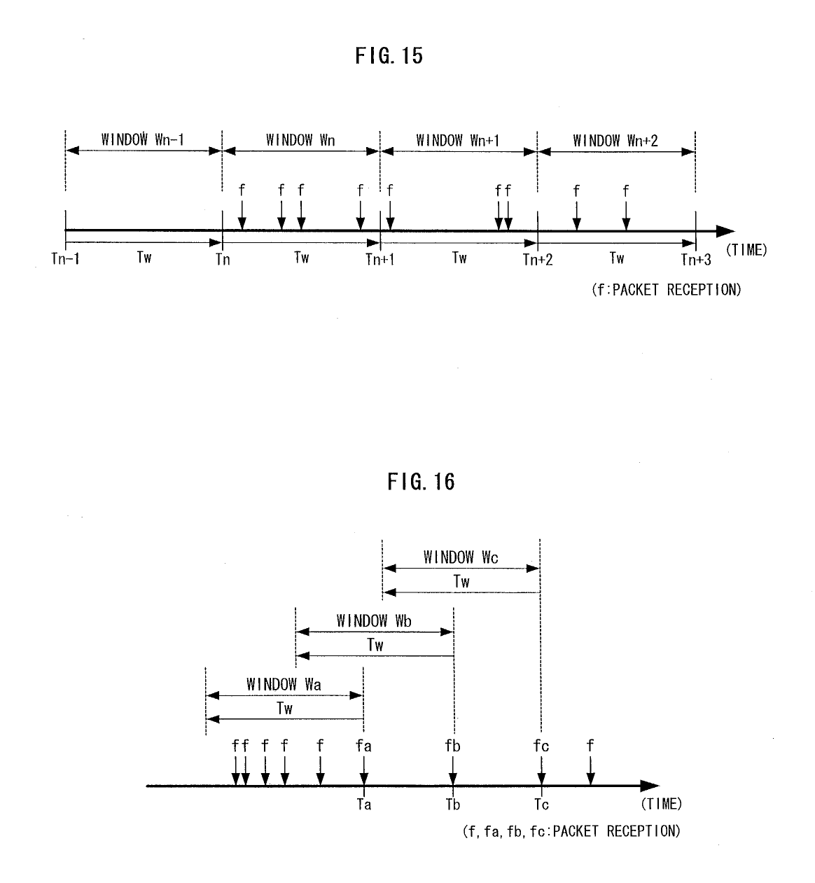

FIG. 9 shows an embodiment (1) of the band control processor 70. This embodiment (1) specifically shows a band control processor 70a of the jumping window band control system described in FIG. 15.

The band control processor 70a is provided with a memory 71 for storing an acceptable byte number 72_1 and a received byte number 72_2 corresponding to the flow No. 90f. An acceptable byte number (this byte number corresponds to an acceptable preset band) of the flow corresponding to the flow No. 90f is preliminarily registered in the acceptable byte number 72_1, and a received byte number of the flow, received within a fixed time T, corresponding to the flow No. 90f is stored in the received byte number 72_2. The initial value of the received byte number is “0”.

The operation procedure of the band control processor 70a will now be described. It is to be noted that this operation procedure is performed for every flow No.

Step S10: The band control processor 70a provides the flow No. 90f to the memory 71, and reads the acceptable byte number 72_1 and the received byte number 72_2 corresponding thereto.

Step S11: The processor 70a updates the received byte number to a new received byte number (new number of received bytes) 72_2=previous received byte number (previous number of received bytes) 72_2+packet length (byte number) 90e, and writes this new received byte number 72_2 to the received byte number 72_2 corresponding to the same flow No. as the flow No. 90f provided at step S10.

Step S12: The processor 70a compares the new received byte number 72_2 with the acceptable byte number 72_1, determines whether or not the preset acceptable band of the flow is maintained, and provides the information 94 (see FIG. 5C), to which the determination result is tagged, to the distributed processor 20.

As described in FIG. 5C, this information 94 is composed of the sequence No. 90d and the tag information 90g. The tag information 90g may be composed of e.g. “OK” indicating that the acceptable band is maintained or “NG” indicating that the acceptable band is violated, or may be composed of color information such as “green”, “yellow”, and “red”.

Step S13: The band control processor 70a clears, at each fixed time interval T referring to the received time stamp 90c, all of the received byte numbers 72_2 entered in the memory 71.

It is to be noted that the band control processor 70a may be provided with a timer (not shown) and may clear all of the received byte numbers 72_2 at each fixed time interval based on this timer without using the time stamp 90c. In this case, the information of the time stamp 90c is not necessary.

In the band control based on the time stamp 90c indicating the time when the packet 90 is inputted to the preprocessor 10, the fluctuation in the information 93 due to the processing at the preprocessor 10 and the distributed processor 20 is less than that in the band control based on the time when the information 93 is inputted to the band control processor 70a, thereby enabling the band control with high accuracy.

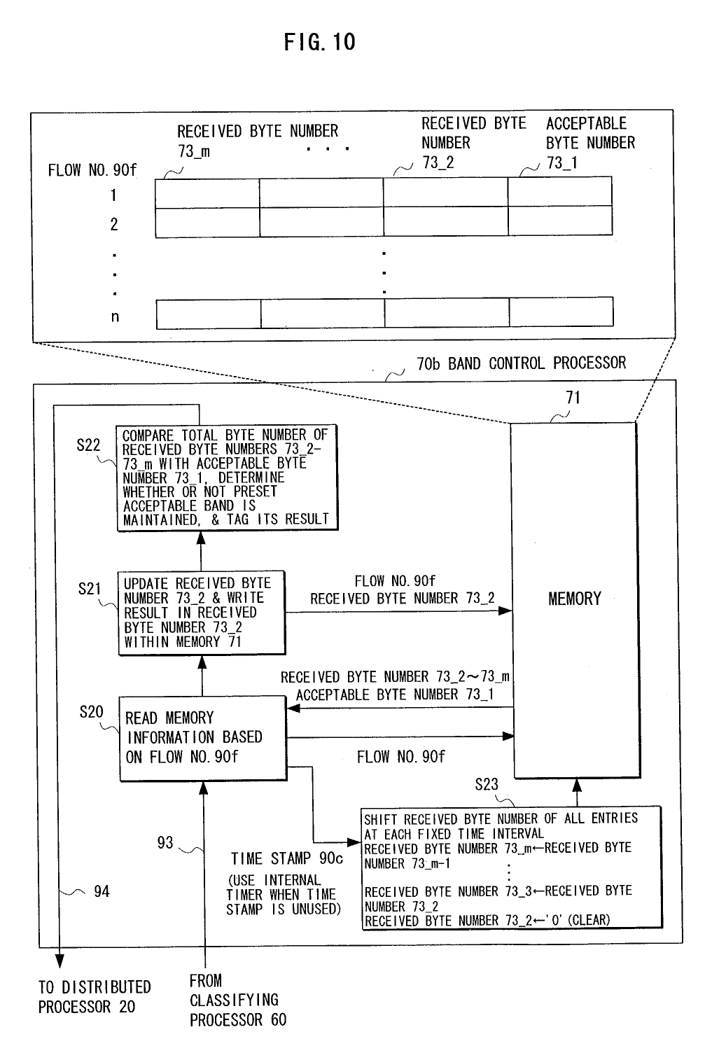

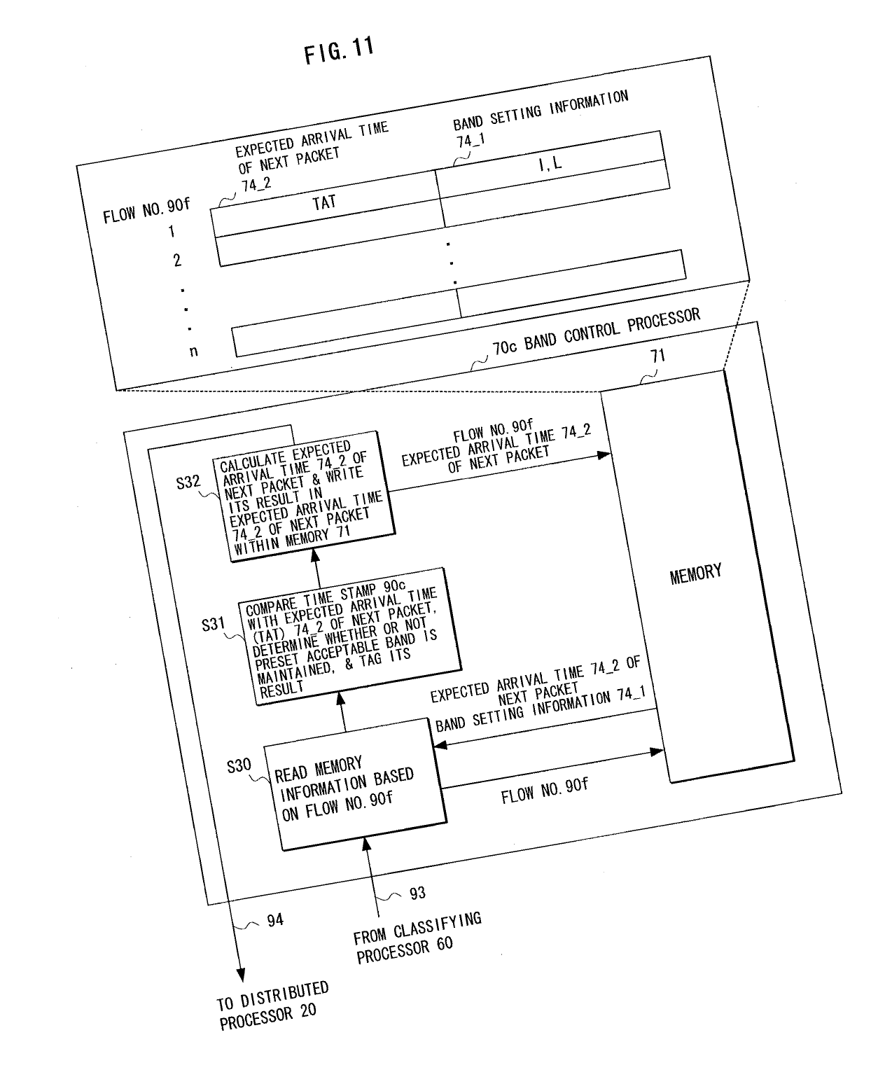

FIG. 10 shows an embodiment (2) of the band control processor 70. This embodiment (2) specifically shows a band control processor 70b of the sliding window band control system described referring to FIG. 16.

The band control processor 70b is provided with the memory 71 for storing an acceptable byte number 73_1 and received byte numbers 73_2-73_{—}m corresponding to the flow No. 90f The acceptable byte number, corresponding to a preset acceptable band, of the flow corresponding to the flow No. 90f is preliminarily registered in the acceptable byte number 73_1.

The received byte numbers of the received flows corresponding to the flow No. 90f are stored in the received byte numbers 73_2-73_{—}m. The initial value of the received byte numbers 73_2-73_{—}m is “0”.

The operation procedure of the band control processor 70b will now be described. It is to be noted that this operation procedure is performed for every flow No.

Step S20: The band control processor 70b provides the flow No. 90f of the received information 93 to the memory 71, and reads the acceptable byte number 73_1 and the received byte numbers 73_2-73_{—}m.

Step S21: The processor 70b updates the received byte number to a new received byte number 73_2=previous received byte number 73_2+packet length 90e (byte number), and writes the new received byte number 73_2 in the received byte number 73_2 of the memory 71.

Step S22: The processor 70b totals the received byte numbers 73_2-73_m, compares this total byte number with the acceptable byte number, determines whether or not the preset acceptable band is maintained, and provides the information 94 (see FIG. 5C), to which the determination result is tagged, to the distributed processor 20.

Step S23: The processor 70b shifts the received byte number (received byte number 73_{—}m← received byte number 73_(m−1), . . . , received byte number 73_3 ← received byte number 73_2, received byte number 73_2 ←“0” (clear)) at each fixed time interval t, based on the time stamp 90c of the received information 93.

It is to be noted that the number (m−1) of the received byte numbers 73_2-73_{—}m is determined by a time interval “t” to be shifted and a window time width Tw.

Also, the band control processor 70b may be provided with a timer, and the shift operation based on this timer may be performed at each fixed time interval without using the time stamp 90c. In this case, the time stamp 90c is not necessary. However, the band control of the original packet 90 is performed based on the time when the information 93 arrives at the band control processor 70b, thereby generating fluctuation of the band control in the same way as the embodiment (1).

FIG. 11 shows an embodiment (3) of the band control processor 70. This embodiment (3) specifically shows a band control processor 70c of the GCRA band control system.

A band control processor 70c is provided with a memory 71 for storing band setting information 74_1 (I: increment parameter, L: limit parameter) and an expected arrival time 74_2 of a next packet (TAT: theoretical arrival time) corresponding to each flow No. 90f. The increment parameter I and the limit parameter L are preliminarily registered.

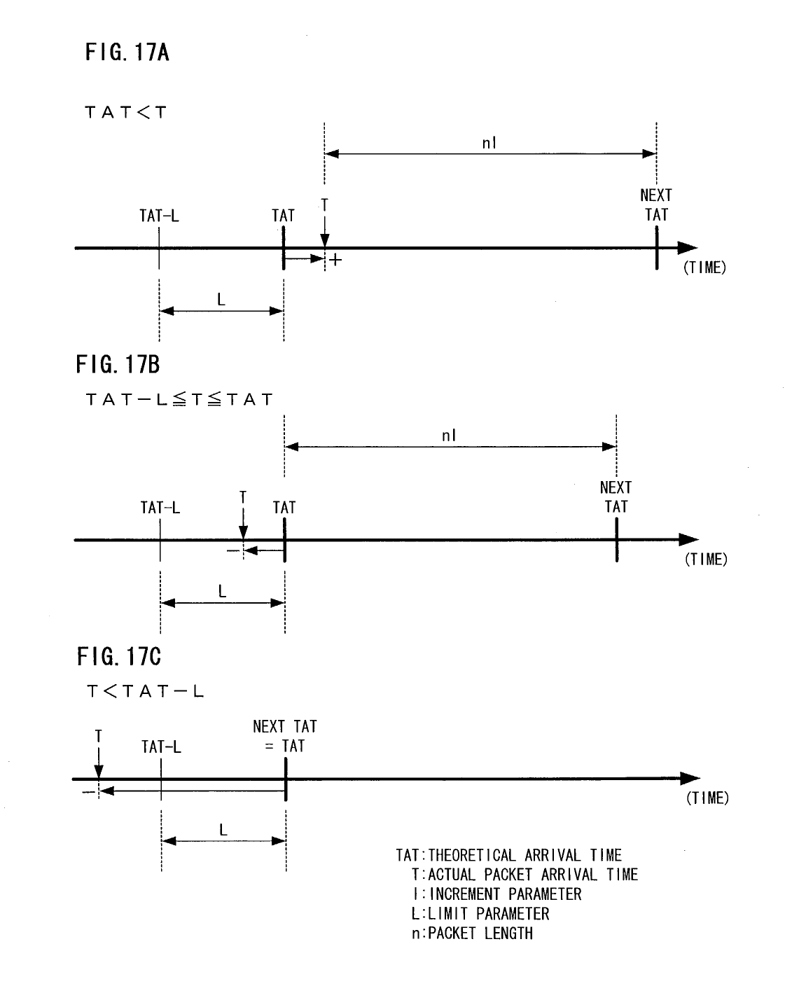

The theoretical arrival time TAT calculated by the equations (1)-(4) described in FIGS. 17A-17C is stored in the expected arrival time 74_2 of the next packet. The initial value of the theoretical arrival time TAT is “0”.

The operation procedure of the band control processor 70c will now be described. It is to be noted that this operation procedure is performed for every flow No. 90f.

Step S30: The band control processor 70c provides the flow No. 90f of the received information 93 (see FIG. 5B) to the memory 71, and reads the band setting information 74_1 and the expected arrival time 74_2 of the next packet corresponding to the flow No. 90f.

Step S31: The processor 70c compares the time stamp 90c (=actual packet arrival time T) with the expected arrival time 74_2 (theoretical arrival time TAT), determines whether or not the preset acceptable band is maintained, and prepares information 94 to which the determination result is tagged.

Step S32: The processor 70c selects any one of the equations (1)-(4) based on the conditions (see FIGS. 17A-17C) of the packet arrival time T, and calculates the theoretical arrival time TAT by the selected equation. Furthermore, the processor 70c writes the calculation result in the expected arrival time 74_2 of the next packet within the memory 71 corresponding to the concerned flow No. 90f, and provides the information 94 (see FIG. 5C) to the distributed processor 20.

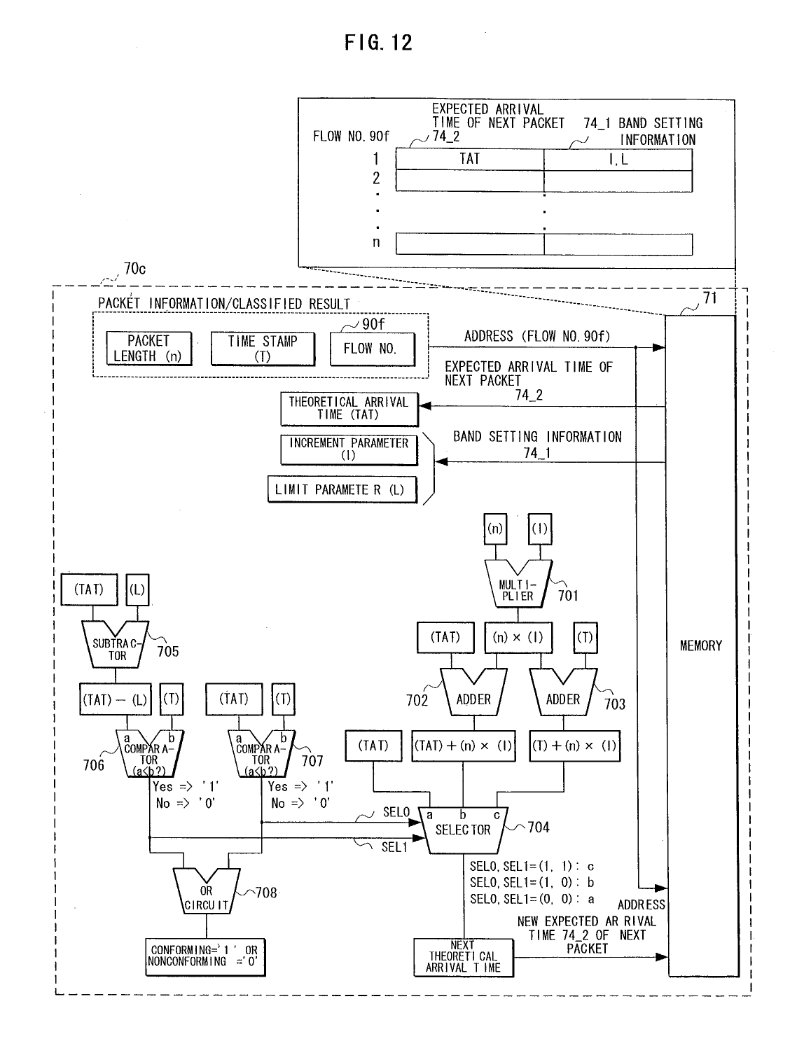

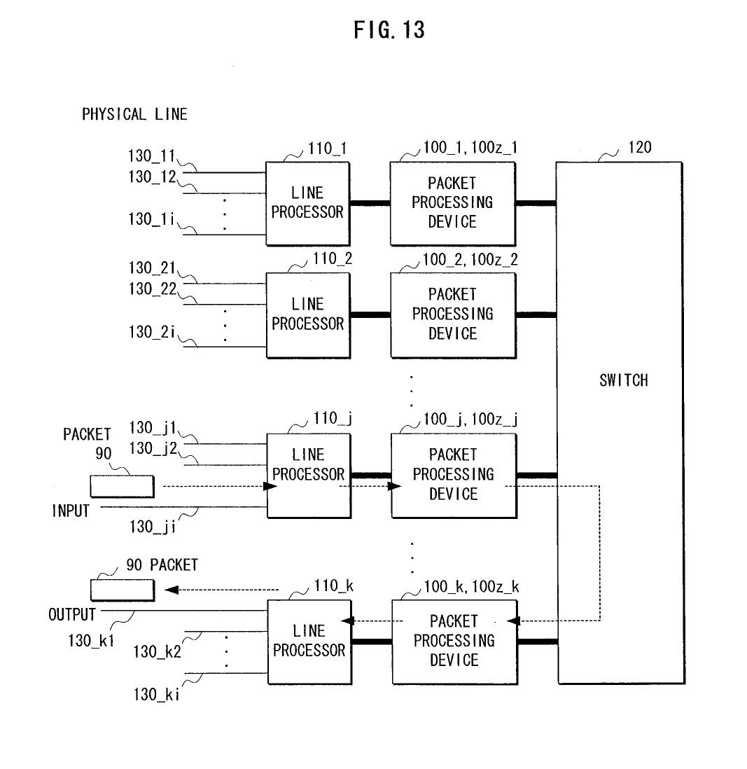

FIG. 12 shows in more detail the operation of the band control processor 70c shown in FIG. 11. Hereinafter, this detailed operation will be described.

The processor 70c receives the information 93 (flow No. 90f, packet length (n) 90e, time stamp (T) 90c, and sequence No. 90d, see FIG. 5B) from the classifying processor 60.

The processor 70c provides the flow No. 90f to the memory 71, and reads the band setting information 74_1 (=increment parameter I, limit parameter L) and the expected arrival time 74_2 of the next packet (=theoretical arrival time TAT).

A multiplier 701 outputs a product (n×I) obtained by multiplying the packet length n and the increment parameter I. An adder 702 outputs a sum (TAT+n×I) obtained by adding the packet theoretical arrival time TAT to the product (n×I). An adder 703 outputs a sum (T+n×I) obtained by adding the time T to the product (n×I).

A subtractor 705 outputs a difference (TAT−L) between the theoretical arrival time TAT and the limit parameter L. A comparator 706 compares the difference (TAT−L) with T, outputs SEL 1=“1” when (TAT−L)<T, and outputs SEL 1=“0” when T<(TAT−L). A comparator 707 compares TAT with T, outputs SEL 0=“1” when TAT<T, and outputs SEL 0=“0” when T≦TAT.

A selector 704 selects “TAT”, “TAT+n×I”, or “T+n×I” respectively when (SEL 0, SEL 1)=(0, 0), (0, 1), or (1, 1), and outputs the same.

These selected data are written in the expected arrival time 74_2 of the next packet within the memory 71.

Thus, when T≦(TAT−L), the next TAT=present TAT. When (TAT−L)<T≦TAT, the next TAT=TAT+n×I. When TAT<T, the next TAT=“T+n×I”.

An OR circuit 708 performs a logical sum operation of SEL 0 and SEL 1, and outputs conforming=“1” or nonconforming=“0” as the band control result. The information 94 to which the band control result is tagged is transmitted to the distributed processor 20.

Hereafter, based on the band control result, a predetermined control such as a discard of the packet 91 is performed.

As described above, a packet processing device according to the present invention is arranged such that a shared resource portion performs a band control of packets based on reception order information (e.g. time stamp, sequence No.) of the packets distributed to distributed processors. Therefore, it becomes possible to perform the band control of the packet without oppressing the band of the packet processing device itself.

Also, the packet processing device according to the present invention is arranged such that a preprocessor preferably assigns a time stamp to a received packet. Therefore, it becomes possible to perform the band control of the packet with high accuracy.

What we claim is:

1. A packet processing device comprising:
a preprocessor for transmitting a received packet to any one of a plurality of output terminals;
a plurality of distributed processors connected to each of the output terminals for processing the packet from each of the output terminals;
a shared resource portion for performing a band control of the packet based on reception order information of each packet distributed to each of the distributed processors; and
a postprocessor for joining the packets from each of the distributed processors to be outputted.

2. The packet processing device as claimed in claim 1 wherein the reception order information comprises time information assigned to the packet.

3. The packet processing device as claimed in claim 2 wherein the preprocessor assigns the time information to the packet.

4. The packet processing device as claimed in claim 2 wherein the distributed processor assigns the time information to the packet.

5. The packet processing device as claimed in claim 2 wherein the shared resource portion includes an order-correction processor for rearranging the packets in time sequence based on the time information.

6. The packet processing device as claimed in claim 2 wherein the reception order information further includes a sequence number, assigned by the preprocessor, indicating a reception order of a packet, and
the shared resource portion includes an order-correction processor for rearranging the packets in time sequence based on the sequence number

7. The packet processing device as claimed in claim 1 wherein the shared resource portion performs the band control by any one of a jumping window band control system, a sliding window band control system, and a Generic Cell Rate Algorithm band control system.

8. The packet processing device as claimed in claim 1 wherein the shared resource portion is further provided with a classifying processor for classifying packets by flow and performs the band control by flow.

9. The packet processing device as claimed in claim 1 wherein each of the distributed processors is further provided with a classifying processor for classifying packets by flow, and the shared resource portion performs the band control by flow.

10. The packet processing device as claimed in claim 1 wherein the preprocessor is further provided with a classifying processor for classifying packets by flow, and the shared resource portion performs the band control by flow.

11. The packet processing device as claimed in claim 1 wherein the reception order information comprises a sequence number indicating a reception order of the packet, and
the shared resource portion is further provided with an order-correction processor for rearranging the packets in order of the sequence number and a timer for clocking a time when the packet is inputted to the shared resource portion itself, and performs the band control based on the time.

12. The packet processing device as claimed in claim 11 wherein the preprocessor assigns the sequence number to the packet.
